(19) United States
(12) Patent Application Publication
(10) Pub. No.: US 2024/0159357 A1
(43) Pub. Date: May 16, 2024

(54) GAS STORAGE APPARATUS AND METHOD

(71) Applicant: Fraenkel Wright Limited, Ringwood Hampshire (GB)

(72) Inventors: Peter Leonard Fraenkel, Ringwood Hampshire (GB); Martin Thomas Ian Wright, Gosport Hampshire (GB)

(73) Assignee: Fraenkel Wright Limited, Ringwood Hampshire (GB)

(21) Appl. No.: 18/282,284

(22) PCT Filed: Jan. 17, 2022
(86) PCT No.: PCT/IB2022/050353

§ 371 Date: Sep. 15, 2023

(30) Foreign Application Priority Data
Jan. 22, 2021 (GB) 2100871.9

(51) Int. Cl. F17C 5/06

(52) U.S. Cl. CPC F17C 5/06; F17C 2201/032; F17C 2201/035; F17C 2225/0123; F17C 2225/035

(57) ABSTRACT

Apparatus comprising a source of a first fluid (204), a fluid displacement device (210) for moving the first fluid from the source to a sealed storage chamber (214), means for introducing a second fluid (207), different from the first fluid into the first fluid prior to reaching the storage chamber, the arrangement being such that the sealed storage chamber receives a mixture of the first and second fluids under a pressure greater than the pressure at the point at which the second fluid is introduced into the first fluid and includes a first fluid outlet (220) for directing the first fluid separated from the second fluid in the storage chamber externally of the storage chamber.

This invention relates to the compressing and storing of gas, and, in particular, the storage of bulk quantities of combustible or valuable gases under pressure.

GB1267681 discloses a method of storing liquefied gas comprising displacing water from a stratum by a purge gas, and then introducing liquefied gas. The purge gas is pumped in through wells and water is withdrawn through encircling wells until the purge gas has produced the desired final volume. The liquefied gas is then introduced through the wells and the water in the stratum adjacent the storage reservoir freezes and thus seals the reservoir. Alternatively, introduction of the liquefied gas may be started when the purge gas has created only part of the desired final volume. The liquified gas subsequently warms to the ground temperature and changes state into a compressed gas.

CN208735268U discloses a method of separating sewage gas from liquid sewage in which a compressor compresses already separated gas into a relatively small storage tank such that the sewage gas is primarily separated from the liquid faction and subsequently compressed.

U.S. Pat. No. 4,320,627 discloses a method and apparatus for the recovery and removal of natural gas from a mine by liquefying and collecting the gas within the mine, and then transporting the liquified gas to the surface in a mobile tank. Natural gas is withdrawn from bore holes in a coal mine and liquefied using liquid nitrogen. The apparatus permits both the liquid nitrogen and the liquefied natural gas to be contained within a same insulated tank, enhancing the portable characteristics. Liquid nitrogen and its vapor are used to cool the natural gas so as to separate water and CO₂. Means are disclosed for controlling the cooling by the cryogenic liquid by regulating the venting flow rate of its vapor in response to the pressure of the liquefied natural gas.

According to a first aspect of the present invention, there is provided apparatus comprising a source of a first fluid, a fluid displacement device for moving the first fluid from the source to a sealed storage chamber, means for introducing a second fluid, different from the first fluid, into the first fluid prior to reaching the storage chamber, the arrangement being such that the sealed storage chamber receives a mixture of the first and second fluids under a pressure greater than the pressure at the point at which the second fluid is introduced into the first fluid and includes a first fluid outlet for directing the first fluid, separated from the second fluid in the storage chamber, externally of the storage chamber.

According to a second aspect of the present invention, there is provided a method of compressing and storing a fluid comprising displacing a first fluid towards a sealed storage chamber, introducing prior to reaching the storage chamber a second fluid, different from the first fluid, into the first fluid, a mixture of the first and second fluids being introduced under increased pressure into the storage chamber, separating the first and second fluids in the storage chamber, storing the second fluid in the chamber and returning the first fluid to externally of the chamber.

Owing to these aspects, it is possible to permit near to isothermal compression of the second fluid entrained within the first fluid.

Preferably, the first fluid is a liquid, such as water for example, and the second fluid is a gas, such, for example a fuel gas which forms bubbles in the first fluid when introduced therein. In addition, it is preferable that first fluid is a liquid substance, and the second fluid is a gaseous substance. Most preferably, the gaseous substance is a fuel gas such as hydrocarbon gases;

biogases such as biomethane; hydrogen, but could also be the noble gases, oxygen or carbon dioxide or any other gas to be stored in bulk under pressure. The first fluid may generally be water but can be any suitable liquid to transport the gas which should be insoluble in the liquid.

Advantageously, fluid pressurisation and displacement are achieved using a pumping device suitable for the first and second fluids.

The chamber is advantageously an underground chamber for containing pressurised gas where the pressurisation is achieved using a pumped flowing first fluid carrying the second fluid, wherein if the first fluid is a liquid and if the second fluid is a gas, the gas will be entrained as bubbles in the liquid. However, the pressurisation technique disclosed could also be used in conjunction with fabricated chambers or pipelines located above ground. Furthermore, there is potential for recovering or storing thermal energy from the circulating liquid needed to compress the gas and also from the ground surrounding the chamber. This heat will be low-grade heat at temperatures no more than about 20 or 30 degrees different from ambient temperatures. Thus, liquid emerging from the chamber can be passed through a heat exchanger integrated with a heat pump so that the system can be a source to provide heat in winter, or a sink to absorb heat and thereby provide cooling (in summer) for commercial, industrial or domestic purposes in the locality. Where underground containments are used, the system is like the source for a very large ground-source heat pump as the containment can extract (or in summer, return) ground heat in addition to recovering the heat from the flow of liquid generated from pumping and compressing the liquid and gas mixture. It would be advantageous to circulate the warmed water recovered from the system via a heat main to a multiplicity (networked array) of heat pumps in the locality as low temperature water can be piped more efficiently without heat loss or gain than water that has already been heated to a higher temperature by a heat pump.

In order that the present invention can be clearly and completely disclosed, reference will now be made, by way of example only, to the accompanying drawings, in which:

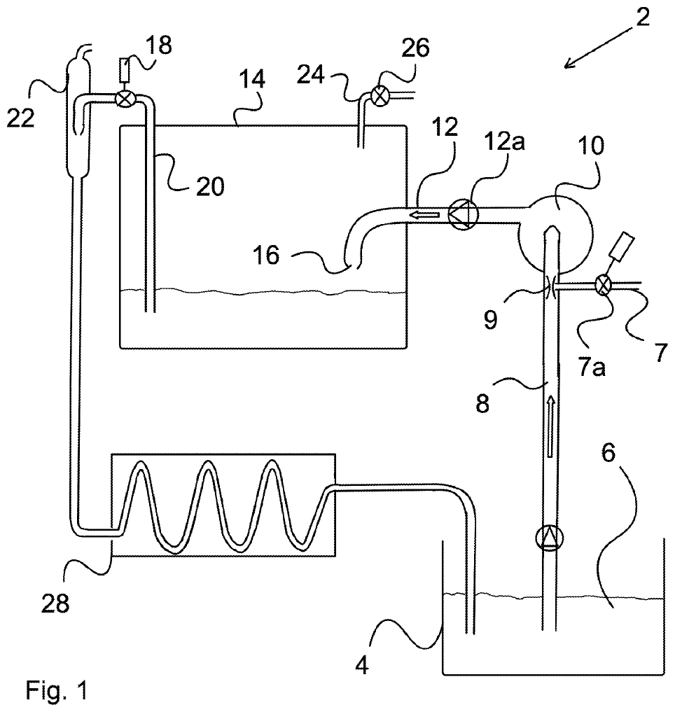

FIG. 1 is a schematic representation of a first embodiment of a near to isothermal gas compressor system,

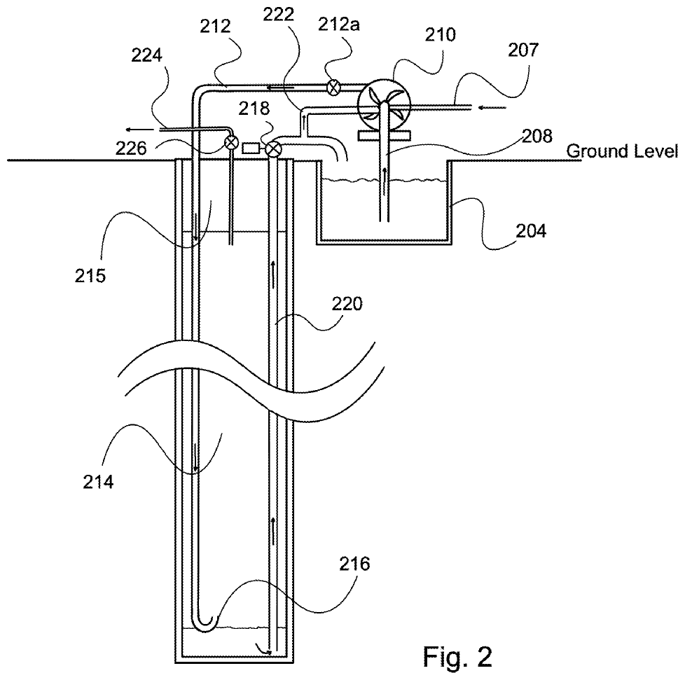

FIG. 2 is a schematic representation of a second embodiment of the near to isothermal gas compressor system,

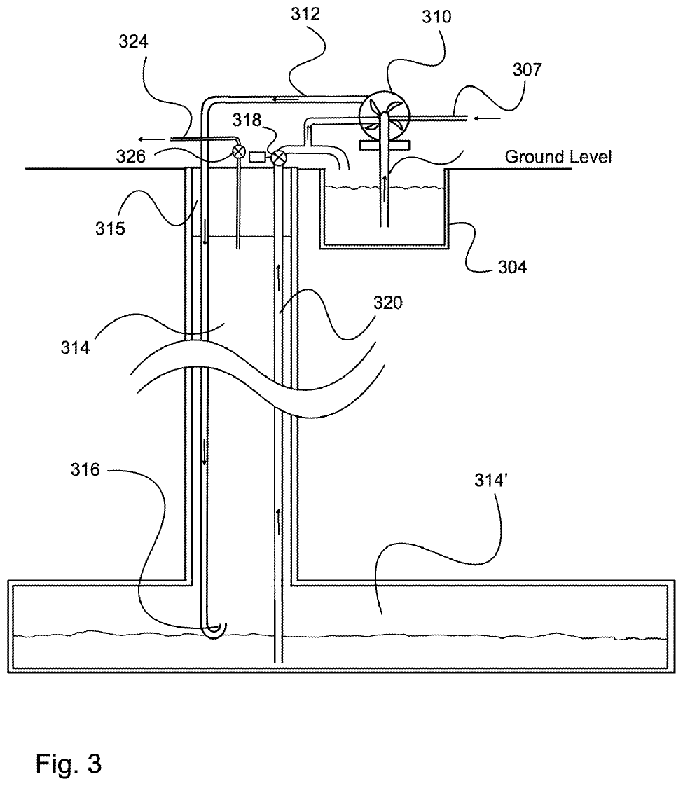

FIG. 3 is a view similar to FIG. 2, but of a second version of the second embodiment,

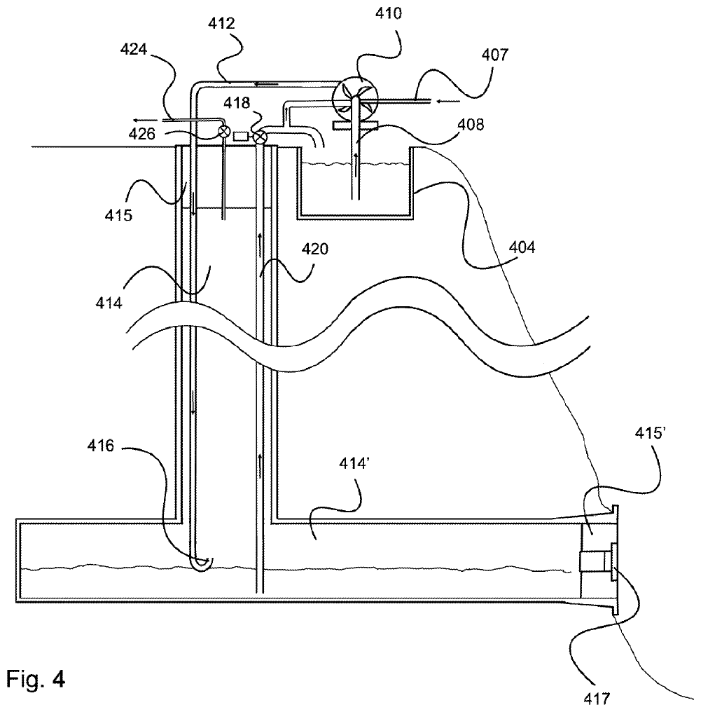

FIG. 4 is a view similar to FIGS. 2 and 3, but of a third version of the second embodiment, and

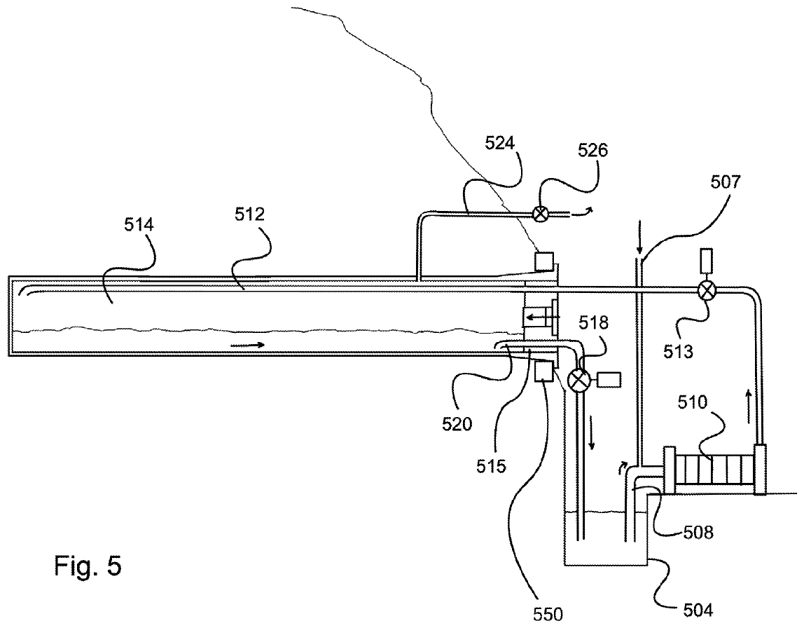

FIG. 5 is a schematic representation of a third embodiment of the near to isothermal gas compressor system

In the Figures, common features will be given corresponding numbers for the sake of clarity and understanding.

Referring to FIG. 1, an isothermal gas compressor system 2 (which gives at least near to isothermal compression) comprises a source 4 of a first fluid 6, which in the example shown is water from a body or container of water, and a source of a second fluid, which in the example shown is a gas flowing through a gas inlet conduit 7. A supply conduit 8 is arranged with one end immersed in the water 6 and its opposite end connected to the inlet of a fluid displacement device 10 in the form of a high-pressure pumping device which can be a positive displacement pump or a rotodynamic (centrifugal) pump. An outlet conduit 12 from the pumping device 10 extends from the pumping device to a sealed chamber or pressure vessel 14 via a non-return valve 12a needed to prevent high pressure gas leaking back when the fluid displacement device 10 has been stopped. The use of a compressing technique involving entraining bubbles of the second fluid (such as fuel gas) in the first fluid (such as water) which is subsequently pressurised by a high-pressure water pumping device 10, is particularly advantageous. The second fluid in the form of a gas is introduced via the gas inlet conduit 7 at relatively low, possibly sub-ambient, pressure to the intake side of the pumping device 10 and it then gets thoroughly mixed with the first fluid, which in the example shown is water, and compressed while passing through the pumping device 10. An optional venturi mechanism 9 in the supply conduit 8 to the pumping device 10 can also be used to reduce the pressure further at that location and assist to induce gas into the water stream. The flow of the second fluid can be controlled by way of a metering valve 7a.

The water and gas mixture discharged through the outlet conduit 12 at much higher relative pressure from the pumping device 10 is injected into the chamber or pressure vessel 14 which may be at the same level as the pumping device 10 (as shown), or above or below the pumping device. The chamber 14 is one that is able to withstand relatively high internal pressures. Facilitation of separating the gas from the water within the chamber 14 can be achieved by injecting the water and gas mixture into the chamber 14 through a spray outlet 16 of the outlet conduit 12. Other techniques of facilitating the separation the gas from the water such as creating a centrifugal or a cyclonic flow (not illustrated) may be used at the point where the mixed flow enters the chamber 14.

The water collects in the lower part of the chamber 14, from where de-gassed water can be extracted from the chamber 14 to externally of the chamber at ambient pressure by letting it be driven from relatively higher pressure inside the chamber 14 to relatively lower pressure through a pressure reduction valve or a non-return valve 18 located in an extraction conduit 20. The water (which may still contain a residual amount of the gas mixed therein) extracted from the chamber 14 can then be recirculated via a gas-trap 22 where, owing to the sudden reduction in pressure when the water exits the confines of the chamber 14, any residual gas bubbles can be separated (by similarly utilising cyclonic or centrifugal flow, as mentioned above) at relatively low pressure, which can then be returned to the gas inlet conduit 7 if desired. Gas bubbles emerging from the water inside the chamber 14 fill the space above the water at the pressure at which the water is delivered. High-pressure gas can then be tapped off as and when it is needed through a gas extraction conduit 24 which includes a suitable valve 26. In addition, sensors, servo-assisted valves and a control system (none illustrated) are able to regulate the pumping device 10 to maintain the required gas pressure in the chamber 14 and to stop the pumping device as and when the maximum desirable pressure is achieved in the chamber.

FIG. 1 also shows an option to pass the water drawn along the extraction conduit 20 to externally of the chamber 14 through a heat exchanger 28 connected to a heat pump or a plurality of heat pumps which can extract thermal energy from gas compression at relatively low temperature and upgrade it to allow the heat energy to be made use of. With large scale systems, the heat transfer may be directed to numerous heat pumps in the vicinity of the system via an insulated circulation pipeline. The heat exchanger 28 also cools the water prior to returning it to the source 4 for re-use, so as to avoid the water going into the chamber 14 getting progressively unacceptably hot.

The de-gassed return water is returned to the source 4 feeding the pumping device 10 (or in some situations, may be returned directly to the intake side of the pumping device 10) where the process repeats as and when necessary under the control of the aforementioned sensors and servo-assisted valves.

Referring to FIG. 2, an alternative technique of pressurising the water and gas mixture utilises a lower pressure pumping device 210 which induces the gas from the gas inlet conduit 207 at relatively low pressure into the water flow from the in-take side (a venturi in the supply conduit 208, not illustrated, may optionally be used to create more suction, as previously mentioned in relation to FIG. 1) and the pumping device 210 also mixes the gas with the water and drives the water and gas bubble mixture along the outlet conduit 212.

The source 204 of the first fluid 206, being water may be a reservoir or a piped water supply, is provided at the ground surface and the suction pumping device 210 is provided to pull water from the source 204. The pumping device may be a centrifugal pump with a fast-rotating impeller, or it could also be a positive displacement pump (such as a piston pump).

The pumping device 210, when operational, will generally have sub-atmospheric pressure at its entry point sucking water from the source 204 so that the second fluid, being a gas, at or near ambient pressure may be injected from the gas inlet conduit 207 into the intake, low pressure side of the pumping device. The flow of the second fluid can be metered by an adjustable valve (corresponding to the valve 7a of FIG. 1) to optimise the ratio of the mixture of the first and second fluids as the system will work most efficiently with the optimum mix ratio. If the induced suction from the pumping device 210 is inadequate, then a venturi mechanism (not illustrated) may be provided in the supply conduit 208 such that the fuel gas can be drawn into the throat of the venturi by the pressure drop caused by acceleration of the fluid flow through the venturi.

A substantially vertical shaft 214 in the form of a deep hole in the ground (similar to a mine shaft) is plugged at the surface region with a pressure-tight plug 215 to seal it from the above-ground atmosphere. The plug 215 accommodates the passage of three conduits which are the outlet conduit 212, the liquid extraction conduit 220 and the gas extraction conduit 224.

The outlet conduit 212 directs a froth of water and gas mixture to descend down the shaft 214 so that as it descends, the gas carrying water is subjected to increasing static pressure which causes compression of the gas within the water stream. The water and gas mixture is introduced into the sealed shaft 214 near its base region so that gas bubbles that have been compressed to whatever static pressure corresponds with the depth of the water and gas mixture.

The water and gas mixture may be emitted through the spray outlet 216 near the base region of the shaft 214 to help the bubbles to separate from the water so that gas collects in the space above the water which gathers in the lower part of the shaft 214, the gas separating from the water partly due to the spray and partly due to the relative buoyancy of the gas bubbles. Means to enhance the separation of the gas from the water may also be used, as already described above. The gas emerging from the outlet conduit 212 will be at a pressure proportional to the vertical distance descended as is the effective density of the water and gas mixture owing to the pressure generated by the pumping device 210 combined with the static head of the column. In this way, pressure exerted on the flow causes gas bubbles to get smaller as the flow descends owing to being compressed. Thus, the gas in the space above the water will approximate in pressure to the pressure of the bubbles emitted from the outlet conduit 212. A non-return valve (or servo-controlled valve) 212a is included in the outlet conduit 212 close to the discharge side of the pumping device 210 to prevent the pressurised gas and water mixture flowing back through the pumping device when it is stopped.

De-gassed water (which may contain a residual amount of gas) returns from near the floor of the shaft 214 to the top of the shaft 214 and externally of the shaft by way of the liquid extraction conduit 220 so that the system is, in effect, an inverted syphon relying mainly on the force exerted by gravity to compress the gas bubbles in the water. In addition, the increased pressure in shaft 214 will tend to cause water to flow upwardly through extraction conduit 220 due to the pressure difference between the shaft and the exterior of the shaft. The pumping device 210 therefore only needs to overcome friction losses plus the difference in density between the descending water flow containing the gas which will be less dense than the ascending water flow from which most of the gas has been extracted. Therefore, the substantially vertical shaft arrangement is very efficient since it needs only a relatively low level of pumping energy to function. The water will tend to flow upwardly under the pressure of the gas in the shaft 214 which is significantly higher than atmospheric pressure at the other end of the extraction conduit 220. A controllable valve 218 is needed to prevent too much water being expelled resulting in the release of gas at times when the pumping device 210 is inactive. In addition, a non-return valve (not shown) could be added to the extraction conduit 220 so that if the flow stops or the pressure reduces ambient air cannot be drawn into the sealed chamber or shaft 214 via the extraction conduit 220. The returned de-gassed water can then be recirculated from the source 204 carrying more gas down into the shaft 214 until the shaft 214 is full of compressed gas at the desired pressure.

As in the case of FIG. 1, the de-gassed water returned to externally of the shaft chamber 214 may pass through the gas trap 222 if necessary, in order to remove any residual gas at relatively low pressure and deliver the water back to the source 204 or directly to the intake of the pumping device 210. Of course, the low pressure separated gas can also be returned to the gas inlet conduit 207 or directly to the in-take of the pumping device 210. Additionally, as is also the case of the embodiment shown in FIG. 1, the water can be passed through the heat exchanger (not illustrated) connected to a heat pump to either extract low grade heat or inject it into the ground so that the system can act as a heat source or dump for a heat-pump heating system. The heat exchanger also cools or stabilises the temperature of the water before it is returned to circulate again through the system.

This technique for compressing gas by combining it as a two-phase mixture of gas bubbles with water has several advantages over using conventional mechanical gas compressors notably:
a) A slow compression process of gas bubbles in water (or another suitable carrier liquid) permits a large degree of isothermal compression of the gas which greatly reduces heating of the gas by conventional adiabatic compression and which is therefore also significantly more energy efficient. This is partly due to the small size of bubbles with a high surface-volume ratio that prevents the gas in the bubble heating too much and partly due to the relatively slow speed of the compression process compared to a mechanical conventional gas compressor.
b) When compressing a fuel gas in a water environment with air excluded it is inherently safer than compressing it mechanically, and heating it in the process, because of the impossibility for sparks or other means of ignition should there be air accidentally present with the fuel gas. This is especially important with hydrogen as a fuel gas as it can explode over a very wide range of air-hydrogen mix ratios and it also has a very high flame propagation velocity meaning that ignition can cause an explosive detonation.

Clearly, with deep shafts large volumes of compressed gas can be safely stored. At ground level, conventional pressure vessels and/or containments need to contain the pressurised gas with significant safety margins due to the obvious danger of leaking gas, especially leaking fuel gas, and the danger of explosion induced by accidental ingress of air. Moreover, there are scaling issues with pressure vessels that make them disproportionately heavy and expensive to build as they get larger, so that it is often less costly to use a multiplicity of smaller pressure vessels above ground which involves a complex system of interconnections, with much more risk of gas leaks and hence fires or explosions.

By using an underground space as a pressure vessel, the geological structure of the surrounding ground can be used to contain the pressure of a much larger space than can conveniently be created with an above ground fabricated pressure vessel. An underground pressure vessel mainly needs to have an impervious lining or internal containment which is completely and closely engaged with the ground surrounding it so that the lining cannot be excessively strained by internal gas pressure and such that the weight of the ground is effectively applied evenly to the entire exterior of the chamber in order to provide the necessary strength to resist bursting. The depth can be calculated to ensure the risk of bursting is virtually zero.

The compression process needs to be initiated with the shaft 214 completely flooded so that no air is present and as more and more water carrying gas circulates the pressure and the volume of stored gas in the sealed shaft will progressively increase until the water level, pressed by the gas, falls to a level where a usable gas pressure is achieved.

High Pressure gas can be drawn off as needed through the gas extraction conduit 224 which includes the valve 226 at either the pressure in the shaft 214 or the pressure can be reduced to some pre-determined and substantially constant supply pressure. The pressure reduction can be with or without recovery of some of the compression energy.

The stored gas may at times be drawn off at a greater rate than it is being supplied, which is of course why a large storage capacity is needed. In such a case, the volume of the gas stored at relatively high pressure will reduce and the internal water level will rise accordingly. When this happens, not only does the volume of the gas decrease but the pressure also decreases because the effective head pressurising the gas in the outlet conduit 212 will be proportional to the depth to the water level in the shaft 214. If gas is drawn off such as to use the entire capacity of the shaft storage space, the water rises to the top and the pressure difference relative to ambient pressure falls to a very low level and, ultimately, zero. Therefore, a system of this kind will need to use a strategy where, for example, the gas can be drawn until the water level in the shaft reaches a pre-determined level which coincides with a minimum acceptable storage pressure of the gas. If a constant gas supply pressure is required then the pressure reduction valve 226 in the conduit 224 to control the supply pressure to the desired level whenever the stored gas is at higher than the required pressure.

Referring to FIG. 3, the arrangement shown is very similar to FIG. 2 in that a substantially vertical shaft 314 is plugged at or near the surface by the pressure-tight plug 315. However, in FIG. 3, at the bottom end of the shaft is a chamber 314′ that is relatively shallow in depth and much wider horizontally than the shaft 314. It could, in fact, be a substantially horizontal tunnel that intercepts the bottom end of the shaft 314 like an inverted substantially T-shape.

In this case, as illustrated, the water level is maintained within the horizontal chamber 314′ (the level never rising into the shaft 314). In this way, the vertical variation in water level can be relatively small since most of the gas storage space is in the horizontal chamber 314′. If, for example, the horizontal chamber 314′ is 100 m below ground level and the chamber is 10 m in diameter, then the variation in head for practical purposes may be from, say, 1 m to, say, 9 m from the bottom of the chamber, which is only up to 8% of the maximum static head. Thus, gas can be drawn off from most of the storage space with much less pressure variation and therefore most of the available storage space is usable, rather than only about half of it. A non-return valve (or servo-controlled valve) equivalent to the valve 212a in FIG. 2 can be included in the outlet conduit 312.

Other advantages of this configuration are:
the gas pressure can be pre-set within quite narrow limits by choosing the depth in the ground to locate the horizontal chamber 314′,
there are virtually no limits to the horizontal spread that is possible, which allows, potentially, a significantly greater storage capacity, and
the outlet conduit and liquid extraction conduit 312 and 320 may be arranged to serve an opening of the shaft 314 which is of relatively smaller diameter as the shaft only needs to accommodate those two conduits and the gas extraction conduit 324. Therefore, the outlet conduit 312 may contain the liquid extraction conduit 320 together with the gas extraction conduit 324 one within the other, resulting in a substantially vertical shaft that is similar to a borehole and therefore much less costly than for the larger diameter version as illustrated in FIG. 2. It should be noted that the containing conveyance pipe could equally be the water extraction conduit 320 containing the outlet conduit 312 and the gas extraction conduit 324. A special manifold will be needed with such an arrangement (not illustrated) to enable connectivity above the ground surface for the separate conduits 312, 320 and 324 to external conveyance conduits. With such an arrangement, practically, nothing more than a borehole would be needed. As a result, the size and cost of the pressure-tight plug 315 would be eliminated or reduced accordingly, although as explained, a special manifold would be required for connectivity at the above ground level.

In the same way as already described above, relatively low pressure gas is introduced through the gas inlet conduit 307, residual gas at relatively low pressure removed from the water at the gas trap (not shown for convenience in FIG. 3 but would be in a position the same as that shown in FIG. 2) could be returned to the gas inlet conduit 307 or directly to the pumping device 310, and high-pressure gas can be tapped off as and when it is needed through the gas extraction conduit 324 which includes the valve 326.

Referring to FIG. 4, the version shown is similar to that of FIG. 3, except that the version of FIG. 4 shows how the substantially vertical shaft 414 with its interconnecting substantially horizontal chamber 414′ might most conveniently be constructed. As illustrated, the chamber 414′ is tunnelled into the side of a rising ground surface (or if no naturally rising ground is available, from the interior of a large excavation such as for example a space such as an open-cast mine or quarry or a purposely excavated hole in the ground). The shaft 414 carrying the outlet conduit 412 and the liquid extraction conduit 420 can then be drilled to the required depth from a higher location, possibly by raise-boring which is less costly than drilling from the surface. A non-return valve (or servo-controlled valve) equivalent to the valve 212a in FIG. 2 can be included in the outlet conduit 412. As previously explained in the context of FIG. 3, the conduits 412, 420 and 424 can advantageously be combined such that one of the three accommodates the other two with a manifold above ground level to provide appropriate connectivity. The chamber 414 may not be required in the event that the vertical conduits are combined as just described, but if the configuration is as indicated in FIG. 4 the horizontal chamber will need to be reinforced and plugged by a second pressure-tight plug 415′ near its opening to make it pressure tight. It should be noted that the chamber 414′ can be designed to be plugged some distance into the hillside from the opening depending upon the amount of gas storage space required such that there is sufficient geological pressure to avoid the need for massive pressure-resistant components surrounding the opening. The plug 415′ could advantageously include some form of openable access 417 to allow occasional entry for maintenance, which obviously can only be carried out after the chamber 414′ is fully de-pressurised and purged of gas. The main advantage of this approach is that very large storage capacity can be provided simply by tunnelling some distance into the ground at relatively marginal cost using standard tunnelling techniques.

It will also be possible to create the required substantially vertical shaft and substantially horizontal chamber using disused deep mine-workings. The vertical shaft might be an existing ventilation or other such vertical shaft or it can be raise-bored at relatively low cost from an existing underground tunnel which will subsequently be plugged to create a pressure tight substantially horizontal space.

In the same way as already described above, relatively low pressure gas is introduced through the gas inlet conduit 407, residual gas at relatively low pressure removed from the water at the gas trap (not shown for convenience in FIG. 4 but would be in a position the same as that shown in FIG. 2) could be returned to the gas inlet conduit 407 or directly to the pumping device 410, and high-pressure gas can be tapped off as and when it is needed through the gas extraction conduit 424 which includes the valve 426.

Referring to FIG. 5, in this third embodiment of the near to iso-thermal compression of gas system, the substantially vertical shaft of FIGS. 2 to 4 is dispensed with. Instead, a substantially horizontal chamber 514 with a suitable pressure-tight plug 515 forms the pressure vessel. A source 504 of water is provided at ground level externally of the chamber 514 proximal to the plugged end of the chamber and a pumping device 510 in the form of a centrifugal pump (which may have multiple stages to achieve the required pressure) or a high-pressure positive displacement pump is provided so as to displace water from the source 504. Water is drawn through outlet conduit 512 and also a metered supply of gas is introduced via the gas inlet conduit 507 at the intake side of the pumping device 510 where the pressure is relatively low (and, as previously described, a venturi may be provided within the supply conduit 508). The pump discharges a flow of liquid containing gas bubbles along the outlet conduit 512 that penetrates the plug 515 and extends to the opposite end of the chamber 514. A controllable valve 513 and/or a non-return valve can be installed in outlet conduit 512 between the pumping device 510 and the entry point into the plug 515 in order to prevent pressurised gas flowing back to the pumping device at time when it has been deactivated or is running too slowly. Water carrying compressed gas as bubbles, emerges from the outlet conduit 512, possibly in a spray form (or, as previously described, with means such as a cyclone or other device) to encourage separation of gas and water, the water being allowed to flow back along the floor of the chamber 514 while continuing to emit any residual gas bubbles into the space above the water level.

The liquid extraction conduit 520 is set at a low level near the floor in the chamber 514 with its in-take end located near the plug 515 forming a route for water to be released through the pressure reducing valve 518 located externally of the plug 515 and which can be set to maintain the correct pressure in the chamber 514. Water could be arranged to pass through the gas trap (not shown in FIG. 5) to remove any remaining gas. As previously described, the outgoing water can also be used as a heat source (or sink) by passing it through a heat exchanger linked to a heat pump, or more likely to a feed pipe serving an array of heat pumps in the vicinity. The large scale of the chamber 514 will yield a relatively large amount of low-grade heat, heat from the pumping and compressing process also being recovered as well as from the surrounding ground through the walls of the containment of the chamber 514.

In the embodiment of FIG. 5, the gas extraction conduit 524 for relatively high-pressure gas which may be conveniently located in the roof of the chamber 514 near to the plugged end and, if necessary, is passed through the pressure regulator valve 526 to deliver the gas at whatever pressure is required. The gas extraction conduit 524 may alternatively simply pass through the plug 515.

This particular arrangement has the advantage of omitting the relatively complicated and costly configurations for pressurising the gas using a substantially vertical drop as used in the versions of FIGS. 2 to 4. The disadvantage is that using a high-pressure pumping device will make the process less isothermal and therefore less energy efficient, although all of the advantages of pressurising gas in a water environment with minimal spark or fire risk still apply. There is also a major advantage that only horizontal tunnelling is involved and that the gas storage space may easily be very much larger than would be practical in the more confined arrangements described for the configurations of FIGS. 2 to 4.

In order to deal with any possible bursting pressure hoop stress near the external end of the substantially horizontal chambers 414′ and 514′, the use of a ring-shaped surrounding tensile member 550 may be concreted into the face of the ground surface as illustrated in FIG. 5, or alternatively the plug 515 may be set some distance into the tunnel such that the greater ground pressure further from the tunnel opening can provide much of the resistance to bursting.

In the construction of the substantially vertical shafts and/or substantially horizontal chambers, there is a need for grouting the tunnel lining after installation to eliminate void spaces between the lining and the surrounding geological formation so that the bursting loads due to gas pressure are transferred evenly through the lining to the surrounding rock. This can be achieved through the provision of appropriate grout pipes (not illustrated) on the exterior or within the tunnel lining to allow grout to be pumped into any voids after the linings are installed.

With all these arrangements the lining of the conduits and gas storage spaces will need to be compatible with the gases concerned. For example, hydrogen causes embrittlement of steel so it will be necessary to line a hydrogen storage system with a material that is not affected by the chemical reactivity of hydrogen such as concrete, some form of rubber or paint coating, etc. Also, compatibility with water or the transport liquid needs to be ensured by using corrosion-resistant coatings or materials.

1. Apparatus comprising a source of a first fluid, a fluid displacement device for moving the first fluid from the source to a sealed storage chamber, means for introducing a second fluid, different from the first fluid, into the first fluid prior to reaching the storage chamber, the arrangement being such that the sealed storage chamber receives a mixture of the first and second fluids under a pressure greater than the pressure at the point at which the second fluid is introduced into the first fluid and includes a first fluid outlet for directing the first fluid, separated from the second fluid in the storage chamber, externally of the storage chamber.

2. Apparatus according to claim 1, wherein the first fluid is a liquid substance.

3. Apparatus according to claim 2, wherein said liquid substance is water.

4. Apparatus according to any preceding claim, wherein the second fluid is a gaseous substance.

5. Apparatus according to claim 4, wherein said gaseous substance is a fuel gas.

6. Apparatus according to any preceding claim, the fluid displacement device is a pumping device.

7. Apparatus according to any preceding claim, wherein the sealed storage chamber is an underground chamber.

8. Apparatus according to claim 7, wherein said underground chamber is a substantially vertical shaft in the ground.

9. Apparatus according to claim 7, wherein said underground chamber is a substantially horizontal chamber in the in the ground.

10. Apparatus according to claim 7, wherein the underground chamber comprises a substantially vertical shaft and a substantially horizontal chamber at the bottom end of the substantially vertical shaft.

11. Apparatus according to claim 9 or 10, wherein the substantially horizontal chamber has an opening on a side of a rising ground surface.

12. Apparatus according to claim 8 or claim 10, wherein the substantially vertical shaft is plugged at its surface region with a pressure-tight plug to seal it from the above-ground atmosphere.

13. Apparatus according to claim 12, wherein the pressure-tight plug accommodates the passage of an outlet conduit extending from the pumping device to the chamber, a liquid extraction conduit of the first fluid outlet and a gas extraction conduit for extracting the stored gas in the chamber.

14. Apparatus according to claim 9 or claim 11, wherein the substantially horizontal chamber comprises a pressure-tight plug.

15. Apparatus according to any one of claims 1 to 6, wherein the sealed storage chamber is a chamber located above ground.

16. Apparatus according to any preceding claim, wherein the first fluid, separated from the second fluid, collects in a lower part of the chamber and can be extracted through the first fluid outlet and recirculated.

17. Apparatus according to claim 16, and further comprising a heat exchanger for recovering or storing thermal energy from the recirculated first fluid leaving the chamber.

18. Apparatus according to any one of claims 4 to 17, and further comprising a gas extraction conduit for extraction of the gaseous substance at relatively high storage pressure from the chamber.

19. A method of compressing and storing a fluid comprising displacing a first fluid towards a sealed storage chamber, introducing prior to reaching the storage chamber a second fluid, different from the first fluid, into the first fluid, a mixture of the first and second fluids being introduced under increased pressure into the storage chamber, separating the first and second fluids in the storage chamber, storing the second fluid in the chamber and returning the first fluid to externally of the chamber.

20. A method according to claim 19, wherein the first fluid is a liquid substance, and the second fluid is a gaseous substance which forms bubbles of the gaseous substance in the first fluid when introduced therein.

21. A method according to claim 20, wherein the compressing includes entraining bubbles of the gaseous substance in the liquid substance which is subsequently pressurised by the pumping device creating a relatively high-pressure.

22. A method according to claim 20, wherein the mixture descends down a substantially vertical shaft so that the gas-carrying-liquid is subjected to increasing static pressure which causes compression of the gaseous substance within the liquid stream.

23. A method according to any one of claims 20 to 22, wherein the returned de-gassed liquid is recirculated for carrying more gaseous substance until the chamber is full of compressed gaseous substance at the desired pressure.

24. A method according to any one of claims 19 to 23, and further comprising passing the returned de-gassed liquid through a heat exchanger.

25. A method according to any one of claims 20 to 24, and further comprising extraction of the gaseous substance at relatively high storage pressure from the chamber, as desired, through a gas extraction conduit.
